(19) United States
(12) Patent Application Publication
(10) Pub. No.: US 2018/0276628 A1
(43) Pub. Date: Sep. 27, 2018

(54) SYSTEMS AND METHODS FOR MONITORING AND TRANSFERRING FINANCIAL CAPITAL

(71) Applicant: 9160-4181 QUEBEC INC., DBA: NCR FINANCIAL SERVICES, Laval (CA)

(72) Inventors: Constantine Radiotis, Blainville (CA); Scott Gerardi, Encinitas, CA (US); Greg Wallis, Gananoque (CA); Sarah Sterns, Montreal (CA); Ryan Foster, Niagara Falls (CA)

(73) Assignee: 9160-4181 QUEBEC INC., DBA: NCR FINANCIAL SERVICES, Laval (CA)

(21) Appl. No.: 15/936,688

(22) Filed: Mar. 27, 2018

Related U.S. Application Data
(60) Provisional application No. 62/477,281, filed on Mar. 27, 2017.

(51) Int. Cl. G06Q 20/10; G06F 17/30; G06F 9/54; G06Q 40/00

(52) U.S. Cl. CPC G06Q 20/10; G06Q 40/00; G06F 9/546; G06F 17/30002

(57) ABSTRACT

The present invention provides a financial transfer transaction system and method that utilizes a financial transfer transaction network and financial transfer module to monitor, coordinate, validate and implement financial transfer transactions as requested by merchants. The financial transfer transaction network will be administered by a provider, and will be able to automatically select a payment processor that is best suited to deal with a particular financial transfer transaction using specific payment methods, or a mix of different payment methods. A financial transfer transaction may be manipulated in a specific way within the financial transfer transaction network due to a number of different factors such as, but not limited to user selections, financial transfer transaction histories, financial transfer transaction user information, and generated sets of rules.

### CROSS REFERENCE TO RELATED APPLICATIONS

This application claims priority to and the benefit of U.S. Provisional Patent Application No. 62/477,281, filed on Mar. 27, 2017 and titled “SYSTEMS AND METHODS FOR MONITORING AND TRANSFERRING FINANCIAL CAPITAL”, the contents of which are incorporated herein by reference as though fully set forth herein.

### FIELD

The present invention pertains to the field of financial transfer transaction processing and in particular to monitoring and transferring financial capital online, to and from multiple entities using multiple payment methods.

### BACKGROUND

Short term financial capital is often required by consumers in need of money. This financial capital may be provided to consumers through various merchants, including through online financial capital providers (also referred to as “OFCP” herein). These OFCPs and other merchants transfer financial capital (also referred to as a financial transfer transaction, or “FTT” herein) to and from a consumer, which may be based on specific frequency schedules (also referred to as “SFS” herein).

The FTTs are facilitated through a mix of different payment methods such as but not limited to Automated Clearing House (also referred to as “ACH” herein), Electronic Funds Transfer (also referred to as “EFT”), electronic cheque, debit cards, credit cards, and other emerging methods. ACH is an electronic network for financial transactions that processes large volumes of credit and debit transactions in batches. It moves money and information from one bank account to another through direct deposit and direct payment via transactions, including ACH credit and debit transactions, recurring and one-time payments, government, consumer and business-to-business transactions, international payments, and payments plus payment-related information. The credit and debt transactions include but are not limited to direct deposit, payroll payments, vendor payments, direct debit such as payment of insurance premiums and mortgage loans.

Each method of payment utilizes its own set of payment processing companies (also referred to as “processors” herein). These processors each use their own unique technological, financial and compliance techniques in administering a method of payment. The specific protocol used by these processors must then be implemented and communicated to the merchants and consumers. The variability and differences in each processor technological, financial and compliance techniques, and communication protocol make it very difficult for a merchant or consumer to interact with multiple processors and/or payment methods.

FTTs fail for a number of different reasons including, but not limited to, bank regulations, insufficient account balances, closed accounts, stop payment requests and other consumer and/or bank driven action. When a FTT fails there are circumstances where the merchant may wish to retry implementing the FTT using an alternative processor or method of payment. Alternatively the merchant may not wish to retry a particular failed FTT. The assessment and implementation of a FTT usually requires the attention of a processor worker, which increases the time and cost required to implement the FTT.

Generally speaking, payment processing is expensive and payment processing relationships can be fragile. When merchants utilize multiple methods of payments and processors the complexity of the FTT will increase significantly. There are competing interests that must be optimized by the merchants in order to assess and overcome these complexities. Some of the factors that must be considered by merchants during a FTT include, but are not limited to where there are FTT failures, costs go up and accounts are at risk of termination, merchants seek to minimize processing costs by favoring those payment processors with lower costs, and failed transactions and/or high risk customers. There needs to be predictability, and suspected high risk transactions must be strategically routed to the proper processing option. Additionally merchant processors typically require a minimum number of transactions to keep the account live. Some merchants such as OFCPs also do not have adequate development resources or bandwidth to integrate processors in a timely manner.

Therefore there is a need to unite many different payment and financial transfer processing methods into a single interface that reports and displays information about FTTs—one that allows multiple merchants to connect to multiple processors via one software interface. Automation of this system is required, and it should store information about FTTs such as historical information of FTT attempts. It is required that the system monitors and reports FTT successes and/or failures as determined across multiple processors and payment methods. There is need for additional/new payment processor accounts to be made available to merchants. There is also need for eliminating the requirement that each merchant integrates with each processor separately—time is of the essence in merchant transactions, and time spent waiting for FTT processing integration can result in lost money and lost consumers. There is need to reduce FTT returns for merchants as these returns can result in high costs spent processing individual FTT returns, and it allows merchants to achieve lower FTT return rates, which provides them with more favorable FTT processing pricing.

This background information is provided to reveal information believed by the applicant to be of possible relevance to the present invention. No admission is necessarily intended, nor should be construed, that any of the preceding information constitutes prior art against the present invention.

### BRIEF SUMMARY

An object of the present invention is to provide a system and method for transferring financial capital. In accordance with an aspect of the present invention, there is provided at least one merchant facilitating a financial transfer transaction; at least one processor capable of processing a financial transfer transaction; a financial transfer transaction network provider; and a financial transfer transaction network configured to monitor, coordinate, validate and implement financial transfer transactions for the at least one merchant, through the at least one processor comprising: a user interface configured to allow the at least one merchant to make selections about the financial transfer transaction; at least one database configured to store information associated with and/or obtained through a financial transfer transaction; and a financial transfer module configured to apply the merchant selections to a financial transfer transaction.

In accordance with another aspect of the present invention, there is provided a financial capital monitoring and transferring method comprising at least on merchant requiring a financial transfer transaction to be processed; the at least one merchant making a request to the financial transfer transaction network provider to have a financial transfer transaction processed; and the financial transfer transaction network provider utilizing the financial transfer transaction network to access at least one processor and to complete the financial transfer transaction.

In accordance with another aspect of the present invention, there is a financial capital monitoring and transferring computing system comprising a microprocessor, a memory, and a communication interface and configured to analyze, monitor, and store information about financial transfer transactions within a financial transfer transaction network; determine a set of rules based upon financial transfer transaction history, which automatically creates a queue of processors to process a financial transfer transaction; and formulate, update and maintain financial transfer transaction histories that contain information about the financial transfer transactions, and store that information within a database.

### BRIEF DESCRIPTION OF THE FIGURES

Embodiments of the present invention will be better understood in connection with the following Figures, in which:

FIG. 1 illustrates a flow diagram of the financial capital transfer process; and

FIG. 2 illustrates a flow diagram of the financial capital transfer process while using historical data related to financial transfer transactions stored within a database.

### DETAILED DESCRIPTION

Unless defined otherwise, all technical and scientific terms used herein have the same meaning as commonly understood by one of ordinary skill in the art to which this invention belongs.

### System/Method Overview

The present invention provides a financial transfer transaction system and method that utilize a financial transfer transaction network (also referred to as “FTTN” herein). The FTTN will monitor, coordinate, validate and implement financial transfer transactions as requested by merchants. The FTTN will interact with at least one processor that is best suited to deal with a particular FTT. A FTT may be manipulated in a specific way within the FTTN due to a number of different factors such as, but not limited to FTTN user selections, FTT histories, FTTN user information, and automatically generated sets of rules.

In one embodiment the FTTs manipulated by the FTTN may include specific payment methods, or a mix of different payment methods such as but not limited to ACHs, EFTs, electronic cheque, debit cards, credit cards, online transfers, recurring and one-time payments, government, consumer and business-to-business transactions, international payments, payments plus payment-related information, and other methods as would be understood by someone skilled in the art.

In one embodiment the merchants that utilize the FTTN may include but are not limited to OFCPs, banking institutions, financial institutions, lending institutions, short term lending institutions, goods vendors, services vendors, governments, and other merchants as would be understood by someone skilled in the art. In this way many merchants are available within the FTTN.

In one embodiment the processors that utilize the FTTN may include but are not limited to OFCPs, banking institutions, financial institutions, lending institutions, short term lending institutions governments, and other processors as would be understood by someone skilled in the art. In this way many different types of processors are available within the FTTN—the FTTN may act to eliminate the need for merchants to integrate with each processor separately.

In one embodiment the financial transfer transaction network provider (also referred to as “FTTN provider” herein) will be able to administer the FTTN. This administration will include but is not limited determining and setting transactional fees that are imposed upon a merchant or processor by the FTTN provider. These transactional fees include but are not limited to set fees, subscription fees, finder's fees, commissions on FTTs, or otherwise as would be understood by someone skilled in the art. These transactional fees may be imposed upon FTTN users such as but not limited to processors, merchants and other users as would be understood by someone skilled in the art. The FTTN provider administration will also include the ability to partition out the availability of specific portions of the FTTN, and specific costs associated with access to those portions of the FTTN.

In another embodiment the FTTN provider will have to ability to administer the network in the same way that similar networks are administered, and would be understood by someone skilled in the art.

### User Interface

In one embodiment merchants will be able to access the FTTN through a user interface. The merchant may access the user interface by using login credentials or some other secure access method as would be understood by someone skilled in the art. The user interface will provide a common platform to access and use the FTTN. The user interface may support multiple profiles for the same merchant, and will allow access to information related but not limited to historical FTT data, merchant selections, merchant profiles, processor selection methods historical costs, lists of processors, relevant third party services, and other information as would be understood by someone skilled in the art.

In one embodiment the user interface will utilize a credential based validation component that compartmentalizes operational and reporting rights based on the user's role at a merchant's organization. For example, the user interface will display only certain information within the FTTN, or allow a FTTN user to make certain selections based on whether or not they have been validated as an executive, financial, operations or other employee by the user interface credential based validation component.

In another embodiment the user interface may allow the merchants to make selections about how to proceed with an FTT. These selections may include, but are not limited to selections about the processors, methods of selecting processors, rules for selecting processors, methods of payment, and other selections as would be understood by someone skilled in the art.

In an additional embodiment the user interface will allow the merchants and other FTTN users to view information related to the FTT and the FTTN. The user interface may display information such as but not limited to individual and aggregate processor performance in reports, a reporting metrics dashboard, alerts, account summaries processing costs, individual transaction history/data or other information as would be understood by someone skilled in the art. The user interface may also provide this information to the FTTN user via email, text message, or other means as would be understood by someone skilled in the art. FTTN users may also subscribe to daily email performance reports and summaries.

In another example, the user interface will allow the FTTN user to set processing or other performance goals and/or limits. FTTN users may be alerted of these goals and/or limits when thresholds are approached or exceeded. For example, if a merchant is allotted a maximum of $100,000.00 worth of processing at a specific processor, an alert could be issued once the amount being processed is approaching that maximum allotment. Alternatively the FTTN user may receive a message that they have reached a preset maximum allowable cap, and will not be allowed to undertake any more transactions. In another example a merchant may have set a maximum percent return rate on the transaction of %15—another FTTN user could use the user interface to set an alert that will be sent if the percent return rate on the transaction reaches %12. This alert would provide notice to the FTTN user, allowing them the ability to take steps to avoid going over maximum percent return rate allowed by the merchant.

### Database

In one embodiment the FTTN will access and store information within at least one database. The database may be configured to store and access information associated with but not limited to an FTT, the FTTN, the user interface, the financial transfer module (also referred to as “FTM” herein), compliance regulations, FTTN users, FTT histories, FTT Costs, industry and merchant blacklists and whitelists for customers, scrubs like state exclusions and ABA routing numbers/bank name exclusions, and other information as would be understood by someone skilled in the art.

### Financial Transfer Module

In one embodiment the FTTN will access and use a FTM. The FTM may influence and alter how the FTTN controls, monitors, coordinates, validates and implements FTTs between merchants and processors. The FTM may perform functions automatically, or may be manually engaged by a FTTN user. The functionalities of the FTM may be administered by the FTTN provider as the provider sees fit.

In another embodiment the FTM will be configured to apply merchant selections to an FTT. The merchant may make selections related to how to proceed with an FTT. These selections will be made in the user interface and stored within a database. When a merchant then requires an FTT to be processed, the selections originally made by the merchant will be used in directing how the FTT is processed.

In one embodiment the FTM will use merchant selections to automatically generate a set of rules, which may then setup queue of payment processors so that FTTs can be attempted with each processor in a particular order as defined by the queue, until a successful FTT has been made. The FTM may also save these rule sets as payment protocols (also referred to as “PP”s herein) so that these PPs can be reused on a repeating basis.

In an additional embodiment a PP will be generated based on other factors monitored within the FTTN. The PPs may be automatically generated by the FTM based on processor performance criteria, merchant selections or preferences, FTT histories, or otherwise as would be understood by someone skilled in the art. It is also contemplated that a PP may be manually formed based on merchant or other FTTN user selections.

In another embodiment the PPs will run on pre-set rules or algorithms that automatically optimize performance of the FTTN and/or an FIT. It is also contemplated that the PPs may utilize a hybrid method of using both pre-set rules and algorithms to automatically optimize performance. The hybrid method may allow an FTTN user to use a weighting system to determine which amounts of pre-set rules and algorithms will be used in the optimization in order to accomplish the specific FTT goals of the FTTN user.

In another embodiment, a PP will utilize a processor cost analysis and/or FTT histories to help make FTT routing decisions. The FTM may utilize the PP to create a specific batch of FTTs, and/or to form a queue of processors—the system may then run a batch of FTTs through a series of bank account processing methods including but not limited to ACH, Check 21, Drafting, and Image Cash Letter until a FTT or batch of FTTs is successful or deemed a failure. Before each step, the FTM may perform validations for that specific processing solution.

In one embodiment the FTM will select certain processors for an FTT based on specific characteristics of the processors. This selection may be automatically made by the FTM, or may be manually selected by a FTTN user. The processors characteristics that may be used for selection include but are not limited to payment method, price per transaction, targeted return rates, compliance regulations (such as National Automated Clearing House Association [“NACHA”] and other regulations), or other characteristics as would be understood by someone skilled in the art. In this way the FTM is able to target specific processors over others.

In another embodiment the FTM will allocate a specific number or percentage of FTTs to a particular processor or set of processors. This allocation may be automatically made by the FTM, or may be manually selected by an FTTN user.

In one embodiment the FTM will technically integrate new payment processors and methods of payment required by a merchant's FTT. This technical integration may automate the procedure for FTT processing, alleviating and reducing merchant costs associated with FTT processing.

In one embodiment the FTM will maintain and monitor FTT result history so that FTT histories can be used for making a decision regarding which processors to route specific FTTs through. For example, the FTM will be able to use FTT histories to develop a high risk processor list, which will help merchants avoid potential failed FTTs. The FTM may retain transaction histories within the database for every attempted FTT request and result across all merchants and processors. These histories may be used for reporting functionality through the user interface, or may help optimize future FTTs.

In another embodiment the FTM will create a shared transaction history database. This database may allow FTTN users to opt into the database, or may create a database for internal use. The shared transaction history database may be used to create alternative databases that help to categorize processors and FTTN users. For example, a negative processor database may be created, which allows merchants to avoid potential high risk FTTs or processors.

In another embodiment, the FTT histories could be used to make underwriting decisions based upon which consumers merchants usually do business with. For example, based on their own historical or shared negative databases, a merchant may eliminate potential consumers before they have gone through the efforts (such as through marketing efforts, etc.) to acquire such a consumer. Processing is the final stage in the consumer acquisition process, and so merchants can use FTT histories and other data in the FTTN to eliminate potential bad consumers prior to processing, which is earlier than is conventionally available.

In another embodiment the FTM will calculate real-time return rates on FTTs and can use that information to help determine FTT routing decisions. For example, the FTM may use this information to meet return rate objectives for processors, and/or within industry and regulatory guidelines. In another example Processor A may be the cheapest option available within the FTTN, however this processor may only allow a %5 return rate. Based on historical data, a merchant could use the FTTN to predicatively assign consumers that perform FTTs within those particular threshold conditions—cheap processing at low return rates. In another example if Processor B is close to exceeding NACHA guidelines, a merchant could push consumers with the best historical FTTs to Processor B in order to ensure that the NACHA guidelines are met. In an additional example Processor C may be set at %7 return rate and will allow as high as %20 percent return rate. A merchant could then push some known higher risk FTTs to this Processor C, which would be capable of processing such FTTs.

In one embodiment the FTM will perform functions prior to commencing an FTT. For example, the FTM may run multiple independent validation routines prior to running an FTT through each processor identified by a PP. These validation routines could include but are not limited to bank validation, validation based on FTT historical information (for either or both of the merchant or processor), validation based on FTT historical information stored within the database, other third party validation services, or otherwise as would be understood by someone skilled in the art.

The invention will now be described with reference to specific examples. It will be understood that the following examples are intended to describe embodiments of the invention and are not intended to limit the invention in any way.

### EXAMPLES

In one example, the FTM will standardize raw data coming from multiple merchants and processors. The FTM will automatically decide which FTTs to run through specific processors. Prior to running the FTTs, the FTM conducts a validation routine that checks historical negative and positive databases and rules for all data touch points including banks, processors, merchants, third party databases, and the FTTN historical data. When running a specific FTT through a processor, the FTM then reformats transaction data into the specific processor requested format. The FTM will then standardize the raw FTT responses from processors, and makes a decision about which FTTs are successful and which are unsuccessful. The FTM will then make a decision about how to deal with unsuccessful FTTs, and may iteratively retry all unsuccessful FTTs with remaining processors in the FTTN until all options are exhausted. Once the FTM has performed all functionality on the FIT, it will send a report on activity to the user interface that may be viewed by an FTTN user. The FTT activity may be reported through the user interface throughout the FTT processing as well. Information related to the processing of the FTTs (including each step of the FTT processing) will be stored within a database for future reference, analysis and use. The whole FTT processing may be accomplished automatically, which may substantially reduce the manual work involved in FTT processing.

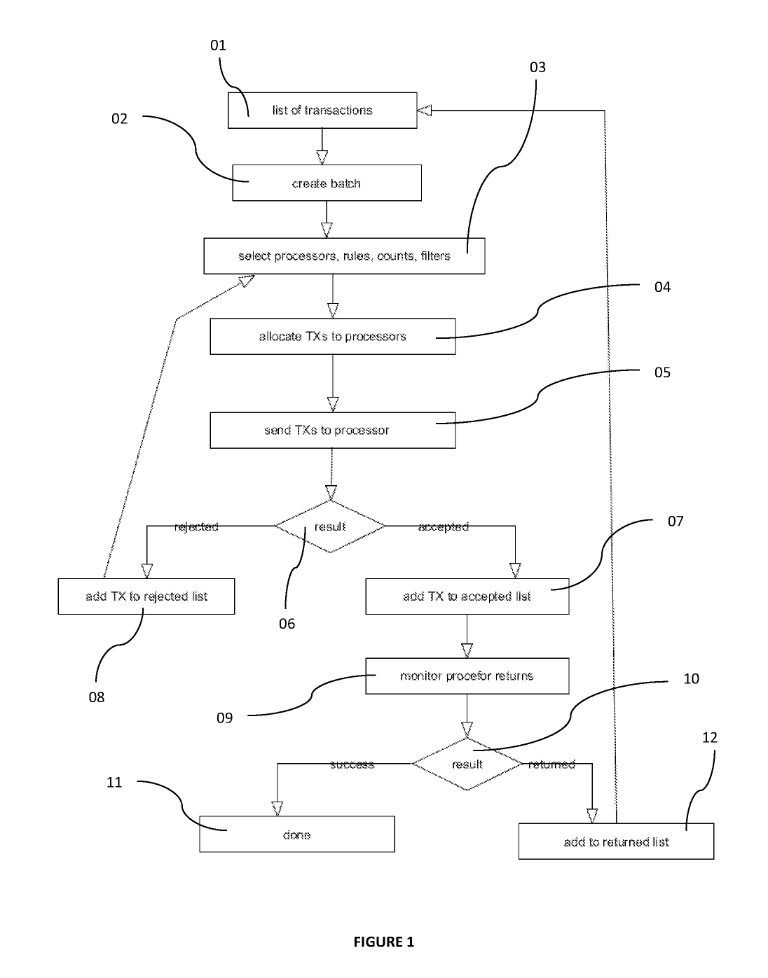

In one embodiment as illustrated in FIG. 1, the FTM will complete several tasks in order to process FTTs. The FTM may accumulate or be provided with a list of FTTs 01, which it uses to create a batch of FTTs 02 to complete. FTT manipulations such as PP utilization, processor selection criteria, FTTN user selections are applied 03, before the FTTs are allocated to specific processors 04. The FTTs are then sent to the processor 05 for processing. A result of processing 06 will be generated and either added to a FTT rejection list 08, or an FTT acceptance list 07. If the FTT is added to the FTT rejection list, the FTT may be sent back to FTT manipulation to run through an alternative set of PPs, processor selection criteria, or the application of other FTTN user selections. If an FTT is added to the FTT acceptance list, the processor will be monitored for the FTT return 09, until the processor provides a result 10. If the processor result is a successful, the FTT will complete 11 and the process will terminate. If the processor result is a returned FTT, the FTT will be added to a processor returned FTT list 12, and the FTT may be sent back to the list of FTTs to be processed.

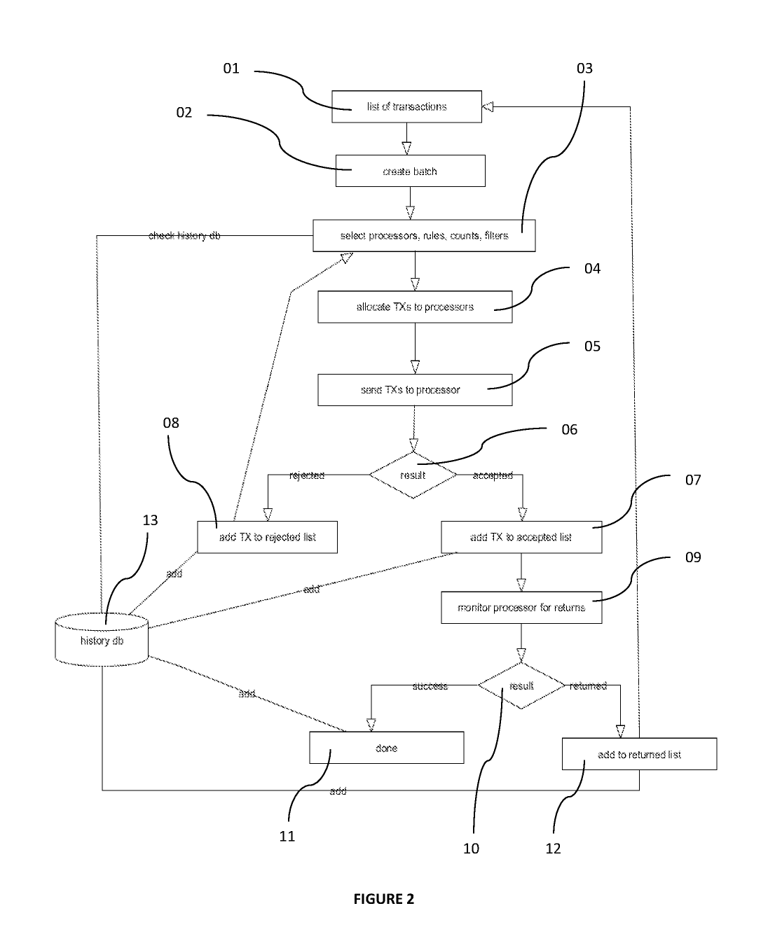

In one embodiment as illustrated in FIG. 2, the FTM will complete several tasks in order to process FTTs while using information about FTTs stored within a database 13. The FTM may accumulate or be provided with a list of FTTs 01, which it uses to create a batch of FTTs 02 to complete. FTT manipulations such as PP utilization, processor selection criteria, FTTN user selections are applied 03, before the FTTs are allocated to specific processors 04. Information related to these manipulations, and how they have affected FTTs in the past may be exchanged with the database and used during this step. The FTTs are then sent to the processor 05 for processing. A result of processing 06 will be generated and either added to a FTT rejection list 08, or an FTT acceptance list 07. Information related to the FTT result and FTT lists may be stored within the database, or accessed to inform these results/lists. If the FTT is added to the FTT rejection list, the FTT may be sent back to FTT manipulation to run through an alternative set of PPs, processor selection criteria, or the application of other FTTN user selections. If an FTT is added to the FTT acceptance list, the processor will be monitored for the FTT return 09, until the processor provides a result 10. Information related to the processor result and processor lists may be stored within the database, or accessed to inform these results/lists. If the processor result is a successful, the FTT will complete 11 and the process will terminate. If the processor result is a returned FTT, the FTT will be added to a processor returned FTT list 12, and the FTT may be sent back to the list of FTTs to be processed.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, personal communication device, server, PDA, or the like and pursuant to one or more, or a part of one or more, program elements, modules or objects generated from any programming language, for example but not limited to languages such as C++, Java, PL/1, or the like. In addition, each step, or a file or object or the like implementing each said step, may be executed by special purpose hardware or a circuit module designed for that purpose.

The scope of the claims should not be limited by the preferred embodiments set forth in the examples, but should be given the broadest interpretation consistent with the description as a whole.

We claim:

1. A financial capital monitoring and transferring system comprising:
at least one merchant facilitating a financial transfer transaction;
at least one processor capable of processing a financial transfer transaction;
a financial transfer transaction network provider; and
a financial transfer transaction network configured to monitor, coordinate, validate and implement financial transfer transactions for the at least one merchant, through the at least one processor comprising:
a user interface configured to allow the at least one merchant to make selections about the financial transfer transaction;
at least one database configured to store information associated with and/or obtained through a financial transfer transaction; and
a financial transfer module configured to apply the merchant selections to a financial transfer transaction.

2. The financial capital monitoring and transferring system of claim 1, wherein the merchant financial transfer transaction selections will automatically define a set of rules utilized by the financial transfer module to setup a queue of processors for financial transfer transactions.

3. The financial capital monitoring and transferring system of claim 2, wherein the merchant financial transfer transaction selections may be combined with other factors to automatically define a set of rules utilized by the financial transfer module to setup a queue of processors for financial transfer transactions.

4. The financial capital monitoring and transferring system of claim 1, wherein the merchant or financial transfer transaction network provider will manually define a set of rules utilized by the financial transfer module to setup a queue of processors for financial transfer transactions.

5. The financial capital monitoring and transferring system of claim 1, wherein the merchant or financial transfer transaction network provider will manually define a set of rules in combination with additional factors utilized by the financial transfer module to setup a queue of processors for financial transfer transactions.

6. The set of rules of claim 5, wherein the merchant or financial transfer transaction network provider manual definition of a set of rules will be informed and automatically adjusted by additional factors utilized by the financial transfer module to setup a queue of processors for financial transfer transactions.

7. The financial capital monitoring and transferring system of claim 1, wherein:
the financial transfer module will access and store information within the at least one database based upon financial transfer transaction histories, financial transfer transaction user information, and/or user selections; and
financial transfer transaction histories, financial transfer transaction user information, and/or user selections will be used to inform the set of rules.

8. The financial capital monitoring and transferring system of claim 1, wherein transactional fees will be imposed on the at least one merchant or processor by the financial transfer transaction network provider for use of the financial transfer transaction network.

9. A financial capital monitoring and transferring method comprising:
at least one merchant requiring a financial transfer transaction to be processed;
the at least one merchant making a request to the financial transfer transaction network provider to have a financial transfer transaction processed; and
the financial transfer transaction network provider utilizing the financial transfer transaction network to access at least one processor and to complete the financial transfer transaction.

10. The financial capital monitoring and transferring method of claim 9, wherein the financial transfer transaction network utilizes information stored within the database related to financial transfer transactions to inform the completion of the financial transfer transaction.

11. The financial capital monitoring and transferring method of claim 9, wherein transactional fees will be imposed on the at least one merchant or processor by the financial transfer transaction network provider for use of the financial transfer transaction network.

12. A financial capital monitoring and transferring computing system comprising a microprocessor, a memory, and a communication interface and configured to:
analyze, monitor, and store information about financial transfer transactions within a financial transfer transaction network;
determine a set of rules based upon financial transfer transaction history, which automatically creates a queue of processors to process a financial transfer transaction; and
formulate, update and maintain financial transfer transaction histories that contain information about the financial transfer transactions, and store that information within a database.
